(19) United States
(12) Patent Application Publication
(10) Pub. No.: US 2002/0013897 A1
(43) Pub. Date: Jan. 31, 2002

(54) System and method for secure delivery of rich media

(76) Inventors: Brennan J. McTernan, Fanwood, NJ (US); Adam Nemitoff, Ridgewood, NJ (US); Altay Murat, Richmond Hill, NY (US)

Correspondence Address: Brown Raysman Millstein Felder & Steiner, LLP, 900 Third Avenue, New York, NY, 10022-4728, US

(21) Appl. No.: 09/858,018

(22) Filed: May 15, 2001

Related U.S. Application Data
(60) Provisional application No. 60/204,386, filed on May 15, 2000.

(51) Int. Cl. H04L 9/00

(52) U.S. Cl. 713/153

(57) ABSTRACT

A system and method for the secure delivery of rich media resources across a computer network having a plurality of servers connectable to one or more clients. Client devices are configured to request and receive rich media resources from a show server and decryption keys from a security server. The show server receives a request for rich media resources from a client device and delivers them to the requesting client, preferably in an encrypted form. The security server responds to the request for decryption keys and transmits keys that are operative to decrypt the rich media resources received by the client device. Upon receipt of the decryption keys, the rich media resources are decrypted and played back on the client device using media player software. During the playback of the received rich media resources, heartbeat packets are generated indicating that the client is playing back the received rich media resources. Heartbeat packets are aggregated and analyzed across all clients connected to the network for receipt and playback of rich media resources, thereby establishing a mechanism that allows precise show viewership measurements to be made.

Applicant(s) hereby claims the benefit of provisional patent application serial No. 60/204,386, titled “AUTOMATIC IPSEC TUNNEL ADMINISTRATION,” filed May 15, 2000, attorney docket no. 38903-014. The application is incorporated by reference herein in its entirety.

### RELATED APPLICATIONS

This application is related to the following commonly owned patent applications, each of which applications are hereby incorporated by reference herein in their entirety:

application Ser. No. 09/767,672, titled “METHOD AND SYSTEM FOR DISTRIBUTING VIDEO USING A VIRTUAL SET,” attorney docket no. 4700/2;

application Ser. No. 09/767,268, titled “SYSTEM AND METHOD FOR ACCOUNTING FOR VARIATIONS IN CLIENT CAPABILITIES IN THE DISTRIBUTION OF A MEDIA PRESENTATION,” attorney docket no. 4700/4;

application Ser. No. 09/767,603, titled “SYSTEM AND METHOD FOR USING BENCHMARKING TO ACCOUNT FOR VARIATIONS IN CLIENT CAPABILITIES IN THE DISTRIBUTION OF A MEDIA PRESENTATION,” attorney docket no. 4700/5;

application Ser. No. 09/767,602, titled “SYSTEM AND METHOD FOR MANAGING CONNECTIONS TO SERVERS DELIVERING MULTIMEDIA CONTENT,” attorney docket no. 4700/6;

application Ser. No. 09/767,604, titled “SYSTEM AND METHOD FOR RECEIVING PACKET DATA MULTICAST IN SEQUENTIAL LOOPING FASHION,” attorney docket no. 4700/7; and

application Ser. No. 09/767,607, titled “SYSETM AND METHOD FOR DISTRIBUTING CAPTURED MOTION DATA OVER A NETWORK,” attorney docket no. 4700/8.

### COPYRIGHT NOTICE

A portion of the disclosure contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to techniques for distributing interactive multimedia content across computer networks. More particularly, the present invention relates to a system and method for seamlessly and securely distributing rich media among a plurality of clients, thereby allowing creators of rich media to retain control over distribution and playback of their content.

Over the past decade, processing power available to both producers and consumers of multimedia content has increased exponentially. Approximately a decade ago, the transient and persistent memory available to personal computers was measured in kilobytes (8 bits=1 byte, 1024 bytes=1 kilobyte) and processing speed was typically in the range of 2 to 16 megahertz. Due to the high cost of personal computers, many institutions opted to utilize “dumb” terminals, which lack all but the most rudimentary processing power, connected to large and prohibitively expensive mainframe computers that “simultaneously” distributed the use of their processing cycles with multiple clients.

Today, transient and persistent memory is typically measured in megabytes and gigabytes, respectively (1,048,576 bytes=1 megabyte, 1,073,741,824 bytes=1 gigabyte). Processor speeds have similarly increased, modern processors based on the ×86 instruction set are available at speeds up to 1.5 gigahertz (approximately 1000 megahertz=1 gigahertz). Indeed, processing and storage capacity have increased to the point where personal computers, configured with minimal hardware and software modifications, fulfill roles such as data warehousing, serving, and transformation, tasks that in the past were typically reserved for mainframe computers. Perhaps most importantly, as the power of personal computers has increased, the average cost of ownership has fallen dramatically, providing significant computing power to average consumers.

The past decade has also seen the widespread proliferation of computer networks. With the development of the Internet in the late 1960's followed by a series of inventions in the fields of networking hardware and software, the foundation was set for the rise of networked and distributed computing. Once personal computing power advanced to the point where relatively high speed data communication became available from the desktop, a domino effect was set in motion whereby consumers demanded increased network services, which in turn spurred the need for more powerful personal computing devices. This also stimulated the industry for Internet Service providers or ISPs, which provide network services to consumers.

Computer networks transfer data according to a variety of protocols, such as UDP (User Datagram Protocol) and TCP (Transport Control Protocol). According to the UDP protocol, the sending computer collects data into an array of memory referred to as a packet. IP address and port information is added to the head of the packet. The address is a numeric identifier that uniquely identifies a computer that is the intended recipient of the packet. A port is a numeric identifier that uniquely-identifies a communications connection on the recipient device.

Once the data packet is addressed, it is transmitted from the sending device across a network via a hardware network adapter, where intermediary computers (e.g., routers) relay the packet to the appropriate port on the device with the appropriate unique IP address. When data is transmitted according to the UDP protocol, however, no attempt is made to inform the sender that the data has successfully arrived at the destination device. Moreover, there is neither feedback from the recipient regarding the quality of the transmission nor any guarantee that subsequent data sent out sequentially by the transmitting device is received in the same sequence by the recipient.

According to the Transmission Control Protocol, or TCP, data is sent using UDP packets, but there is an underlying “handshake” between sender and recipient that ensures a suitable communications connection is available. Furthermore, additional data is added to each packet identifying its order in an overall transmission. After each packet is received, the receiving device transmits acknowledgment of the receipt to the sending device. This allows the sender to verify that each byte of data sent has been received, in the order it was sent, to the receiving device. Both the UDP and TCP protocols have their uses. For most purposes, the use of one protocol over the other is determined by the temporal nature of the data. Data can be viewed as being divided into two types, transient or persistent, based on the amount of time that the data is useful.

Transient data is data that is useful for relatively short periods of time. For example, a television transmits a video signal consisting of 30 frames of imagery each second. Thus, each frame is useful for 1/30^{th} of a second. For most applications, the loss of one frame would not diminish the utility of the overall stream of images. Persistent data, by contrast, is useful for much longer periods of time and must typically be transmitted completely and without errors. For example, a downloaded record of a bank transaction is a permanent change in the status of the account and is necessary to compute the overall account balance. Losing a bank transaction or receiving a record of a transaction containing errors would have harmful side effects, such as inaccurately calculating the total balance of the account.

UDP is useful for the transmission of transient data, where the sender does not need to be delayed verifying the receipt of each packet of data. In the above example, a television broadcaster would incur an enormous amount of overhead if it were required to verify that each frame of video transmitted has been successfully received by each of the millions of televisions tuned into the signal. Indeed, it is inconsequential to the individual television viewer that one or even a handful of frames have been dropped out of an entire transmission. TCP, conversely, is useful for the transmission of persistent data where the failure to receive every packet transmitted is of great consequence.

One of the reasons that the Internet is a successful medium for transmitting data is because the storage of information regarding identity and location of devices connected to it is decentralized. Knowledge regarding where a device resides on a particular part of the network is distributed over a plurality of sources across the world. A connection between two remotely located devices can traverse a variety of paths such that if one path becomes unavailable, another route is utilized.

Each network on the Internet is uniquely identified with a numeric address. Each device within a network, in turn, is identified by an IP address that is comprised of a subnet address coupled with a unique device ID. According to version four of this standard (“IPv4”) an IP address is a 32-bit number that is represented by four “dot” separated values in the range from 0 through 255, e.g., 123.32.65.72. Each device is further configured with a subnet mask. The mask determines which bits of a device's IP address represent the subnet and which represent the device's ID. For example, a device with an IP address of 123.32.65.72 and a subnet mask of 255.255.255.0 has a subnet address of 123.32.65 and an ID of 72.

Each packet of data sent by a device, whether it is formatted according to the UDP or TCP protocols, has a header data field. The header is an array of bytes at the beginning of a packet that describe the data's destination, its origin, its size, etc. When a sender and recipient are both located within the same subnet, the recipient device's network hardware examines network traffic for packets tagged with its address. When a packet addressed to the recipient is identified, the network hardware passes the received data off to the operating system's network services software for processing.

When a sender and recipient are located in different subnets, data is relayed from the originating subnet to the destination subnet primarily through the use of routers. While other physical transport methodologies are available, e.g., circuit switched transmission systems such as ATM (Asynchronous Transfer Mode), the majority of computer networks utilize packet switched hardware such as routers. A router is a device that interconnects two networks and contains multiple network hardware connections. Each network connection is associated with, and provides a connection to, a distinct subnet.

Two tasks are performed when a packet, destined for a subnet that is different from the subnet it is currently in, reaches a router within the current subnet. First, the router examines the subnets that it is connected to via its network hardware. If the router is connected to the packet's destination subnet, it forwards the packet to the router in the appropriate subnet. If the router is not directly connected to the packet's destination subnet, it queries other routers available on its existing connections to determine if any of them are directly connected to the destination subnet. When a router directly connected to the destination subnet is discovered, the packet is forwarded to it. Where a router connected to the destination subnet is not found, however, the router propagates the packet to a top level router that is strategically placed to allow access, either directly or through other top level routers, to the entire Internet. A registration authority under government oversight currently maintains these top-level routers.

The transmission method described above is referred to as the unicast method of transmission, whereby a sender establishes a unique connection with each recipient. By utilizing a unicast model, the specific address of the receiving machine is placed in the packet header. Routers detect this address and forward the packet so that it ultimately reaches its intended recipient. This method, however, is not the most efficient means for distributing information simultaneously to multiple recipients. The transmission method that best facilitates broadcasting to many recipients simultaneously is multicasting.

Multicasting relies on the use of specialized routers referred to as multicast routers. These routers look only for data packets addressed to devices in the range of 224.0.0.0 through 239.255.255.255. This address range is specifically set aside for the purpose of facilitating multicast transmissions. Recipients wishing to receive multicast packets watch for a specific IP address and port within the multicast address space.

Under the multicast model, the sender transmits packets to a single address, as opposed to the unicast model where the data is transmitted individually to each subscribing recipient. The multicast routers handle replication and distribution of packets to each subscribing client. The multicast model, like the broadcast model, can be conceptually viewed as a “one-to-many” connection and, therefore, must use the UDP protocol. UDP must be utilized because the TCP protocol requires a dialog between the sender and receiver that is not present in a multicast environment.

As previously described, Internet Service Providers or ISPs, provide connections between local networks and the Internet. A router is used to connect the customer's local network to the ISP and forwards data packets not addressed to devices within the local network to the ISP for relay across the Internet to the packet's intended recipient. There are no regulations, however, regarding the types of routers supported by ISPs and many of them do not incur the cost of providing and maintaining multicast routers. Because of this limitation, not all systems can subscribe to multicast addresses.

Many ISPs restrict the transmission of UDP packets across their networks. Since these packets do not require a persistent link between sender and receiver, they are referred to as anonymous packets. Security issues involved with this anonymity is the reason for restrictions on the transmission of these packets, which has the twofold effect of restricting the use of UDP packets and preventing users from subscribing to multicast services.

There is thus a need for a system and method that allows users to receive the secure delivery of rich media resources irrespective of the means of communication while ensuring that resource producers a compensated for the use of their property. Strategies are required to identify individual users and the amount of resources they utilize to more equitably account and compensate for system usage.

### BRIEF SUMMARY OF THE INVENTION

It is an object of the present invention to solve the problems described above relating to existing content delivery systems.

It is another object of the present invention to provide a secure mechanism for the delivery of rich media content that ensures content owners are compensated for content usage.

It is another object of the present invention to provide a secure mechanism for the delivery of rich media resources that ensures content availability.

It is another object of the present invention to more effectively track the use of content by consumers.

The above and other objects are achieved by a computer-implemented method for receiving a securely distributed show comprising a plurality of rich media resources over a computerized network operative to connect a plurality of clients and servers. The method involves retrieving the rich media resources in an encrypted format. Each of the encrypted resources is tagged with a unique resource identifier. The decryption keys corresponding to the unique resource ids of the encrypted rich media resources are identified and retrieved from a Security Server along with a unique session identifier. The rich media resources are decrypted with the retrieved decryption keys and played to the end user as a show by presenting the retrieved and decrypted rich media resources.

Heartbeat data packets may be generated at regular intervals while the end user is playing the show. These heartbeat data packets are used to calculate the total time that a user is watching a show, which is useful in generating billing statistics. The heartbeat data packets are tagged with the session identifier and transmitted to a Security Server for aggregation and indexing by session id. The aggregated heartbeat data is transmitted by a plurality of security servers to a Central Server to generate payment information. The method may also comprise downloading a media player to facilitate playback of the retrieved show, the media player being identified by a unique player identifier. The user performing the download operation can provide demographic data, which is associated with the unique identifier of the player being downloaded and aggregated across a plurality of users.

The above and other objects are also achieved by a computer-implemented method for providing the secure distribution of a show comprising a plurality of rich media resources over a computerized network operative to connect a plurality of clients and server. The method involves receiving each rich media resource comprising the show at a Security Server, each of the resources identified by a unique resource identifier. A plurality of encryption/decryption keys are generated, one for each rich media resource, which is used to encrypt the resources. A plurality of records is also generated to associate each encrypted rich media resource with the appropriate decryption key. The decryption keys and records are sent to a central server to distribution to other Security Server located throughout the network. A check may also be performed at the Security Server to determine if the received resource was previously encrypted. If the check determines that a resource was previously encrypted, it is not subsequently encrypt multiple times. Instead, the previously encrypted resource is utilized.

The above and other objects are achieved by a computer-implemented system for providing for the secure distribution of a show comprising a plurality of rich media resources over a computerized network operative to connect a plurality of clients and servers. A Security Server is used to the unique resource id of rich media resources, and handle key requests from clients. The Security Server's encryption system generates encryption/decryption keys, one pair for each resource. A separate encryption key is used to encrypt each resource. A Key Manager creates a record for each resource encrypted to associate each decryption key with the encrypted rich media resource that it is capable of decoding. A Show Server is provided to supply rich media resources to the Security Server for encryption, to manage the encrypted rich media resources, and to respond to client requests for rich media resources.

The system may also comprise a web server configured to serve media player software to a requesting client and further configured to collect and aggregate demographic data regarding clients. The web server may further comprise show server guides containing addresses of Show Servers thereby allowing clients to locate resources located thereon. A Central Server is provided to collect the aggregated demographic data from a plurality of web server. The system may comprise a media player operative to retrieve a show comprising a plurality of rich media resources from the Show Server and issue requests to the Security Server for decryption keys corresponding to the unique ids of the rich media resources comprising the show. The media player comprises functionality that allows it to generate heartbeat data packets for broadcast across the network. These heartbeat data packets are aggregated at the Security Server across a plurality of media players. A Central Server collects heartbeat data form Security Servers attached to the network to create usage statistics regarding all media players in use.

### BRIEF DESCRIPTION OF THE DRAWINGS

The invention is illustrated in the figures of the accompanying drawings, which are meant to be exemplary and not limiting, in which like references are intended to refer to like or corresponding parts, and in which:

FIG. 1 is a block diagram presenting a configuration of hardware components according to one embodiment of the present invention;

FIG. 2 is a flow diagram presenting the process of generating and uploading rich media to a server for receipt and playback by client devices according to one embodiment of the present invention;

FIG. 3 is a flow diagram presenting the process downloading rich media for playback on a client device according to one embodiment of the present invention; and

FIG. 4 is a flow diagram presenting the process of playing received rich media on a client device according to one embodiment of the present invention.

### DETAILED DESCRIPTION OF THE PREFERRED EMBODIMENTS

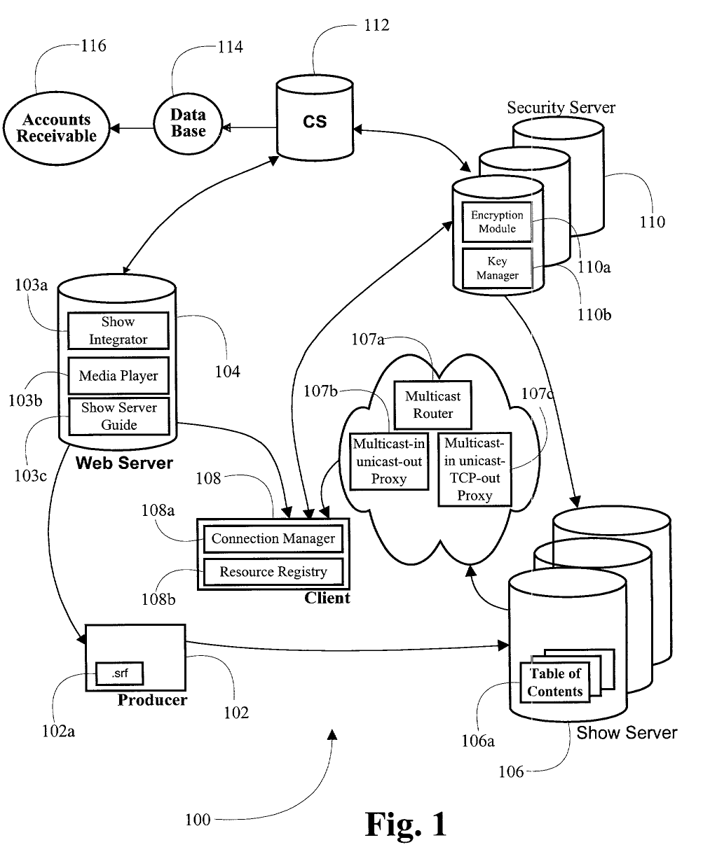

Preferred embodiments of the present invention are now described with reference to the drawings in the figures. With reference to FIG. 1, one configuration of a system in accordance with the present invention includes various hardware components, including client devices 108, media producers 102, web servers 104, show servers 106, security servers 110, central servers 112, and routers 107a-107c. Users access rich media through the use of client devices 108. Client devices 108 may be any general purpose computing devices with the capacity to access a data network 100 including, but not limited to, personal computers, wireless computing devices, and personal digital assistants. The data network 100 may be any type of computerized network capable of carrying data, such as the Internet, Intranets, LANs, WANs, etc. Moreover, the data network may be comprised of a plurality of disparate networks and network types.

Producers 102 create rich media presentations by assembling show resources using the Show Integrator 103a. The Show Integrator is a stand-alone GUI application that is retrieved from the Web Server 104, using HTTP, FTP, or any other suitable data transfer protocol. The producer 102 selects rich media elements that comprise the show and arrange them graphically within a scene, which are sequenced over time (interaction data). The Show Integrator GUI 103a gives the producer 102 flexibility in viewing the scene, allowing it to be viewed along an animation timeline, as a two dimensional representation of one possible client configuration, or as multiple client configurations simultaneously. These functions are described further in commonly owned patent application serial no. PCT/US01/02224, titled “SYSTEM AND METHOD FOR DELIVERING RICH MEDIA CONTENT OVER A NETWORK,” which has been incorporated by reference herein.

A Producer 102 uses the Show Integrator 103a to assemble one or more scenes into a show. The show is then packaged as an “.srf” or “Sorceron Release File” file 102a. This file 102a is a collection of all the resources and data regarding the interaction of these resources needed by the client 108 to recreate a show. Alternatively, producer 102 may forgo packaging the resources as a single file and instead use the Show Integrator to create individual resources and data regarding the interaction of these resources. The terms “show”, “.srf” and “resources” will be used interchangeably throughout.

Each resource used in the presentation of a show is tagged with a unique identifier. Likewise, a show comprising a plurality of resources and interaction data is assigned a single identifier. The identifier may take any form that allows a client 108 to uniquely identify a desired resource from all other resources being distributed using the present invention. For example, one method is to use Globally Unique Identifiers (“GUIDs”) through third-party software well known in the art, or another method is to use the address of the producer creating the resource may be appended to a randomly generated alphanumeric identifier. In this manner, no two resources will be tagged with an identical identifier, allowing retrieval of any resource.

The show or resource data is transmitted by the producer 102 to a Show Server 106 for distribution to requesting clients 108. A table of contents 106a is also provided by the producer 103 to allow clients 108 to identify resources needed to recreate a show that already reside on the client device 108, thereby eliminating the need for duplicative downloads.

The Show Server 106 is configured to manage resources and .srf files 102a received from Producers 102 and transmit these data to requesting Clients 108. In order to encrypt a show, the Show Server 106 initiates a communication channel with a Security Server 110. Upon establishing communication with a Security Server 110, the Show Server 106 uploads resources or .srf files for encryption. The Security Server 110 employs a public/private key encryption architecture to encrypt show resources. Public/private key encryption involves the use of a mathematical algorithm to generate public/private key pairs. Data encrypted by a private key can only be decrypted with its corresponding public key. As a corollary, the public key can only be used to successfully decrypt data that has been encrypted by its corresponding private key.

Depending on whether an .srf file or multiple resources are uploaded, the Security Server 110 uses one or more private keys to encrypt the received data using its encryption module 110a. The encryption module 110a may be implemented in hardware, software, or a combination of the two. The encryption module 110a generates one or more public/private key pairs for the received data and proceeds with encryption using the generated private key or keys.

Upon encryption of each resource, a key manager 110b generates a record in its key management table associating or correlating the newly created public key with the resource identifier for the resource encrypted with the public key's private key. The key/identifier record is used by the key manager 110b to allow the retrieval of the public key associated with a specific resource or show requested by a Client 108. The Security Server 110 returns the encrypted file to the Show Server 106 initiating the encryption transaction.

The Security Server 110 forwards the key or keys, along with the key/identifier record or records, to the Central Server 112. The Central Server 112 forwards the received keys and key/identifier records to other Security Servers 110 located throughout the network to minimize the time necessary to retrieve keys for the decryption of show resources when requested by a client 108. Furthermore, this allows multiple Security Servers to host the keys required to playback a show, allowing a certain level of fault-tolerance among Security Servers without degrading system performance or usability. Upon receipt of each key and key/identifier record, the Security Server 110 will proceed with registering the key/identifier record to allow clients to retrieve decryption key by reference to the key record.

Client devices 108 contain and execute browser software to identify shows for viewing. Web Server 104 serves HTML pages to Client devices 108 containing links to one or more available shows hosted by Show Server 106. Links to shows are comprised of HTML tags that identify the type of media attempting to be accessed. A driver or plug-in must be retrieved in order to view or playback media types not native to or supported by the Client 108. If the Client 108 does not possess the required rich media plug-in and stand-alone player 103b, the client retrieves it from the Web Server 104. Before a download is allowed, the Web Server collects demographic and other identifying information from the Client 108 using techniques well known to those skilled in the art. The player and plug-in 103b are encoded with an identifier to uniquely identify the player and plug-in and thereby associate it with the Client 108.

At regular intervals, the Central Server 112 polls the Web Server 104. The Central Server 112 retrieves stored demographic and player identification data for each client that has downloaded the media player since the last polling. The duration between polling intervals is variable and related to the business needs of the entity implementing the distribution network. It may be executed on an hourly, daily, weekly or monthly basis. The Central Server 112 stores retrieved player id and demographic data in a database 114. The database 114 may be physically integrated with the Central Server 112, or may be in communication with the Central Server 112 across the communications network 100.

Client device 108 downloads and installs media player software 103b that contains Connection Manager software 108a. Client 108 executes Connection Manager software 108a in order to negotiate and maintain a connection with Show Servers 106, which provide content used in delivering a presentation or show. The Connection Manager 108a executes routines on the Client 108 when an attempt is made to establish a connection with a Show Server. As explained more fully below, the routines include directing the client 108 to establish a multicast, unicast UDP, or unicast TCP connection based upon the requirements of the network 100 that the client device 108 is using to connect to the data network 100. The connection manager software 108a further determines appropriate bandwidth and ensures that resources are being received appropriately. These functions are described further in commonly owned patent application Ser. No. 09/767,602, titled “SYSTEM AND METHOD FOR MANAGING CONNECTIONS TO SERVERS DELIVERING MULTIMEDIA CONTENT,” which has been incorporated by reference herein.

When a client 108 requests the transmission of content by selecting a link presented on a Web page, an appropriate Show Server Guide 103c is transmitted based on the request. The Show Server Guide 103c comprises a listing of all Show Servers 106 connected to the network 100 that are capable of transmitting the content requested by the client 108. The client 108 receives the Show Server Guide 103c and attempts to initiate a connection with the first Show Sever entry in the guide 103c. The Connection Manager software 108a opens up packet-based Internet connections between a Show Server 106 and the Client 108 based on the server address and port number listed in the Show Server Guide 103c.

The Client 108 first attempts to make a multicast connection with the Show Server 106 by subscribing to a multicast router 107a that the Show Server 106 is transmitting rich media resources through. If the client 108 is incapable of initiating a direct connection with the multicast router 107a, due to any number of limitations imposed by the client's network service provider, a connection is attempted via a Multicast-in unicast-out proxy 107b that emulates the multicast feed but provides a unicast UDP connection. For example, the AOL online service does not currently support or allow for multicast connections. Where the client 108 is connected to a network 100 that is incapable of receiving both multicast and unicast UDP packets, the client 108 connects to the Show Server 106 by way of a Multicast-in unicast-TCP-out proxy 107c that responds to TCP based requests for data.

When a connection between the Client 108 and a Show Server 106 is accomplished, the Client downloads a Table of Contents 106a stored in an .srf file. The Table of Contents 106a is a list of the rich media resources necessary to allow the Client to playback the requested show. The Client 108 uses the Table of Contents 106a to determine what resources it needs. Each resource has an associated Channel number. This Channel number is an abstraction of a Server connection and allows the Client to receive this data without having to know about the nature of the connection. The proprietary channel number conceals the details of whether the connection is via Multicast, Unicast UDP or Unicast TCP/IP from the client.

When the Client 108 receives resources from a Show Server 106 to present a show to the user, each rich media resource has been encrypted with a private key by the Security Server 110. The downloaded Media Player 103b uses the Table of Contents to search the Client system's resource registry 108b to determine if any of the required resources are already resident on the Client 108. This eliminates duplicative transmission of resources and decreases bandwidth and transmission time required for reproduction of a show. The Media Player 103b determines the missing resources and retrieves them from the Show Server 106.

The Player 103b requests a matching public key from a Security Server 110 for each retrieved resource. A request is transmitted indicating the unique identifiers of the required shows or resource data, which is processed by the Security Server's 110 key manager 110b to locate the public keys associated with the identifiers for the requested resources or shows. The Security Server 110 responds to the client request with the appropriate public keys and the resources are decrypted. The Security Server 110 also provides the Player with a session identifier. The session id is a reference to the unique id of the Player 103b and the unique id of the show being viewed.

The use of public and private key pairing to enable the viewing of a show insures a revenue stream for the entity implementing the distribution network. Furthermore, because the components of the system are distributed across a network, producers are ensured delivery integrity while viewers are ensured playback integrity.

The connection between the Player 103b and Security Server 110 remains open for the duration of the show during which the Player 103b sends heartbeat packets to the Security Server 110 at regular intervals. These heartbeat packets consist of the unique session id and a time stamp. They are generated and transmitted a regular intervals as required by the business needs of the entity implementing the distribution network, e.g., every 30 seconds, every minute, etc. The time stamp is used to measure the elapsed time from the beginning of the viewing of a show to the generation of the heartbeat packet. In this manner, the system is capable of generating statistics regarding how long each show is viewed for by each client. The distinction is that by tracking show viewership, as opposed to tracking show serving, the system can capitalize on broadcasting over the Internet. When broadcasting, many viewers can be watching a single feed. Utilizing standard systems well known to those skilled in the art, the number of viewers watching such a show would be unknown. By having each Player 103b update the Security Server 110 with viewing statistics, a mechanism is provided whereby precise measurements of show viewership can be made.

Each Security Server 110 retains this heartbeat data. The Central Server 1l2 polls the Security Servers 110 at regular intervals to retrieve accumulated heartbeat data, which is stored in either an integrated or network accessible database 114. The duration between polling intervals is variable and set according to the business needs of the entity implementing the distribution network. The database may be analyzed by industry standard database or data mining software as is known to those skilled in the art. The results of the analysis are sent to an accounts receivable module 116 where billing statistics are generated based on the amount of resources used or any other suitable method on which to base billing for use of the system.

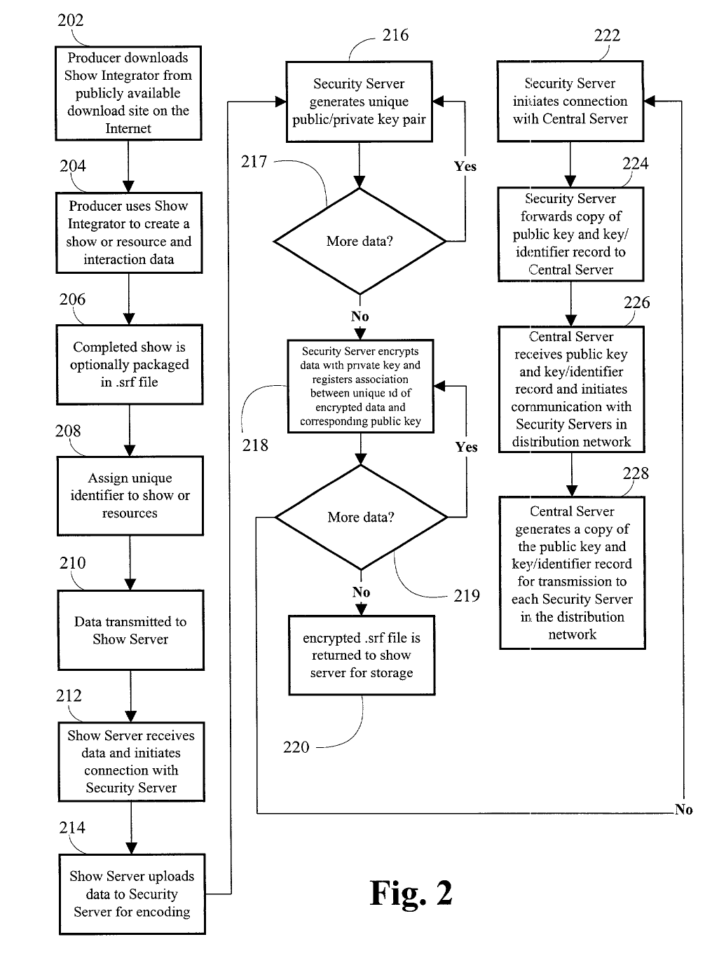

Turning to FIG. 2, one embodiment of a method for utilizing the system by a Producer to generate and upload content to the system is presented. Producers navigate a computer network, using tools such as a browser or FTP client as is well known to those skilled in the art, to locate and retrieve the Show Integrator software, step 202. Typically, the producer retrieves the Show Integrator software from a publicly available web site administered by the entity implementing the distribution network, although alternative repositories or delivery mechanisms are contemplated by the invention.

The producer uses the Show Integrator to create a show, step 204. The Show Integrator is a stand-alone GUI application used by the producer to assemble various rich media resources in a time variant manner to create a presentation to viewer. The producer organizes resources required for the show and the complete show is packaged by the Show Integrator as an .srf file, step 206. Alternatively, the producer may forgo packaging the resources as a single file and instead use the Show Integrator to create individual resources and data regarding the interaction of the resources.

Each resource used in the presentation of a show is tagged with a unique identifier, step 208. Likewise, a show comprising a packaged plurality of resources and interaction data is assigned a single identifier. The identifier may take any form that allows each resource to be uniquely identify a desired resource from all other resources being distributed using the present invention. This unique identifier is also used to associate resources with the public key capable of decrypting the encrypted resource, as will be explained further herein. The producer transmits the completed and packaged show or individual resource and interaction data across a computer network to a Show Server for encryption and distribution to requesting clients, step 210. Alternatively, the resources and data regarding the interaction of these resources may be transmitted to the Show Server as individual data items for processing.

The Show Server receives the data from the producer across a network and initiates a connection with a Security Server, step 212. The Show Server opens and initializes a communication channel with the Security Server over which the .srf file or resources are uploaded to the Security Server for encryption, step 214. The Security Server receives the uploaded data, e.g., resources or .srf files, and generates a public/private key pair, step 216. This key pair is unique in that files encrypted with the generated private key may only be decrypted by its associated public key and no other public or private key. Similarly, a file is irretrievably encrypted if the public key associated with the private key used to encrypt the file is lost or misplaced. Where there is more than one data item to be encrypted, step 217, additional key pairs are generated, step 216. The public/private key pair or pairs are generated and the received .srf file or resource is encrypted with the private key, step 218. When the file is encrypted, a key/identifier record is also generated correlating the unique identifier of the data encrypted with the fingerprint of the public key capable of performing the decryption. Where multiple resources or .srf files are provided to the security server, step 219, each one is encrypted and an individual key/identifier record generated, step 218.

The newly encrypted data is returned to the Show Server that uploaded it for storage and delivery to requesting clients, step 220. The Security Server also initiates a communication channel with the network's Central Server using techniques well known to those skilled in the art, step 222. Once the communication channel is opened and initialized, the Security Server forwards a copy of the public key used to decrypt the show along with the key/identifier record to the Central Server, step 224. The Central Server receives the uploaded data and initiates a plurality of communication channels with other Security Servers located throughout the distribution network, step 226. Alternatively, the Central Server sequentially opens individual communication channels with each Security Server located throughout the distribution network. The Central Server generates a copy of each public key and its key/identifier record and transmits it to each Security Server in the distribution network, step 228. In this manner, each Security Server is capable of providing keys to requesting clients for any show or resource by querying its key manager with a unique show or resource identifier and retrieving the appropriate public key to allow decryption.

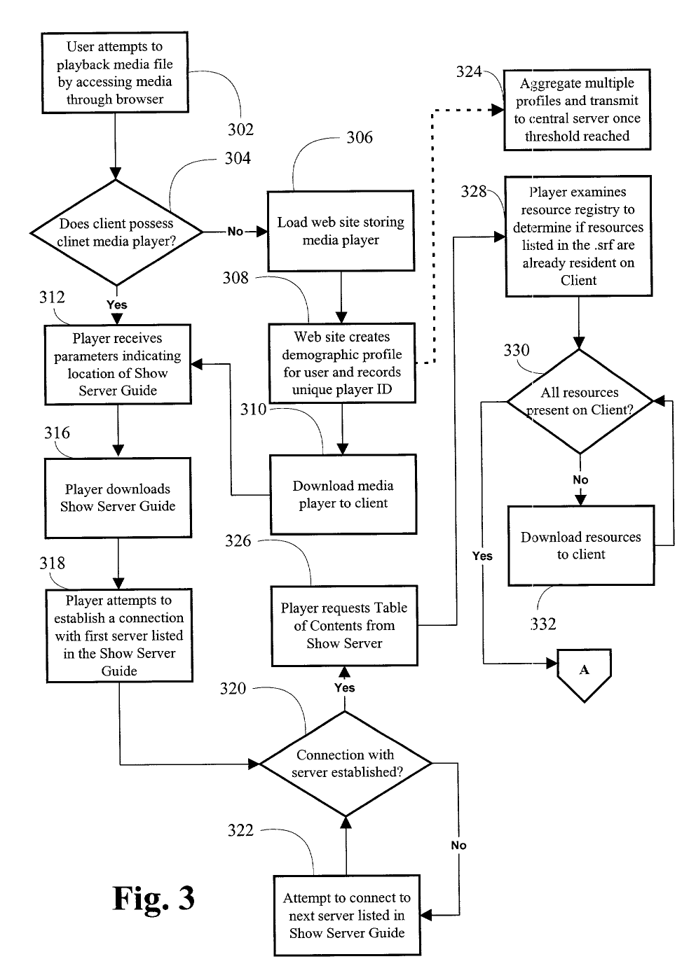

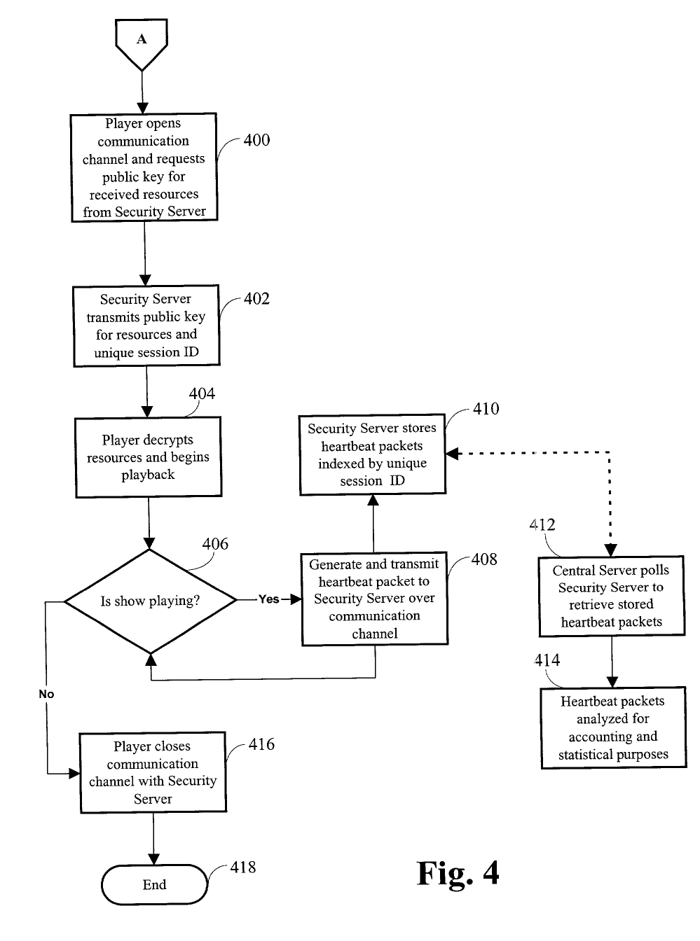

Turning now to FIGS. 3 and 4, one embodiment of a method for utilizing the system by a client to retrieve and playback content is presented. A user navigating the World Wide Web (“WWW” or “the Web”) or other interactive content delivery system browses pages containing links to content. For example, a user navigates to a page containing links to the desired content, which is loaded and viewed using a web browser or other viewer capable of rendering pages encoded in Hypertext Markup Language (HTML). Other navigation and rendering systems are also contemplated by the invention, such as systems based on Gopher or that serve pages encoded using alternative markup languages.

Independent of the navigation and rendering system used, the user selects a link to the desired content for playback on the client device, step 302. A check is performed on the client device to determine whether the client has an appropriate plug-in or other software add-on that provides functionality to play back the selected content, step 304. If the necessary plug-in is not present on the client device, a web page or other content page containing links to download the playback software is loaded into the client's content viewer, step 306. Preferably, the link selected by the user to retrieve the content contains parameters that instruct the client as to the location of a server containing the necessary plug-in. Alternatively, supplemental links can be provided linking the page containing the link to the content to a server hosting the plug-in required to playback the selected content.

The site containing the playback software collects demographic information regarding the client including, but not limited to, name, address, age, residence, occupation, connection speed, etc., step 308. The site also records the unique id of the player that is being transmitted to the client and associates it with the client's demographic profile. Once the profile is complete, the media player is downloaded to the client, step 310. In a separate out-of-line process, multiple client profiles are aggregated by the server until a threshold number of profiles is met, at which point the aggregated profiles are transmitted to the Central Server for analysis and storage, step 324.

The client determines that the required plug-in is present on the client device, step 304, and parameters provided within the link to the selected content instruct the client where the Show Server Guide for the selected content is located, step 312. Alternatively, a plurality of Guide Servers may be provided to the client as a list or index whereby the client determines the appropriate Guide Server to initiate a connection with to retrieve the Show Server Guide.

Furthermore, the Guide Server may be the same server hosting the selected content, e.g., the Show Server. The Show Server Guide is transmitted to the client using standard HTTP techniques well known to those skilled in the art or any other suitable data transmission techniques, step 316.

The client receives the Show Server Guide via a network and examines the Guide's first entry, step 318, attempting to establish a connection with the listed Show Server. In one embodiment, the Show Server Guide is a listing of all Show Servers on the network capable of serving the show selected by the user. The Show Servers are preferably listed in order of priority of connection. Alternatively, a Guide Server may store a number of Server Guides, each listing different Show Servers, or listing the same Show Servers in different orders of priority. This alternative allows the Guide Server to select one of the Server Guides based on the current use of resources across all Show Servers in order to effectuate load balancing.

A connection attempt is initiated between the client and the server whereby the Connection Manager tries to establish an acceptable connection with the server, step 320. If the client fails to acquire a connection with the Show Server 320, the Connection Manager is initialized with a subsequent server address from the Show Server Guide at which point the Connection Manager once again attempts to initiate a connection with the subsequent server, step 322. When a connection is established between the client and the server, step 320, the client requests and downloads an .srf file containing a Table of Contents from the Show Server, step 326. The Table of Contents lists the resources needed to view the show being requested and the channels associated with these resources. The player examines the client's resource registry to determine if resources listed in the Table of Contents are already resident on the client, step 328. Where all necessary resources are not present on the client, step 330, the client downloads any missing resources via an appropriate channel, 332. The Show Server sends and receives packets to and from the channel it is associated with and maintains statistics, such as numbers of bytes received, number of packets dropped, etc. It also actively monitors and alters bandwidth dynamically.

Turning to FIG. 4, once all necessary resources are present on the client device, the player opens a communications channel with a Security Server and requests the public keys associated with the rich media resources that are to be used to playback the requested show, step 400. Alternatively, the resources may be packaged as a single file, e.g., an .srf file, and have a single identifier as such. In this instance, only one identifier will be transmitted to the Security Server. According to one embodiment of the invention, the key request simply takes the form of a listing of resource identifiers. In response to the key request, the Security Server queries its listing of key/identifier pairs to retrieve the appropriate public key associated with the resource to be decrypted by the Client. This key or keys are transmitted to the Client along with a unique session identifier, step 402. Using the received key or keys, the player decrypts each encrypted resource that is to be used in the presentation of the show, step 404.

The decrypted resources are used to play back the show on the Client device. As the show plays, a check is preformed to ensure that the show is playing, e.g., has not been paused or stopped, step 406. If the check determines that the show is playing, a heartbeat packet is generated and transmitted to the Security Server that provided the decryption key required to view the show, step 408. The check is performed periodically by player according to the business needs of the entity implementing the distribution network. The heartbeat packet is generated and transmitted and processing returns to step 406 to determine if the player is still playing the show. When it is determined that the show has stopped playing, step 406, the player closes the communications channel with the Security Server, step 416, and the routine ends, step 418.

The Security Server stores received heartbeat packets from all connected clients, which are indexed according to the packet's unique session id, step 410. At regular intervals, the Central Server opens a separate communication channel with each Security Server located in the distribution network and individually polls each them to retrieve their stored and indexed heartbeat packets, step 412. The interval over which the Central Server polls the Security Servers is determined by the business needs of the entity implementing the distribution network. Aggregated heartbeat packets retrieved by the Central Server are stored and periodically analyzed for accounting and statistical purposes, step 414.

As previously described in detail, producers create and combine resources to create a show for playback and presentation on a client device. Resources may be combined and distributed as an .srf file or as individual resources for retrieval by requesting clients. Resources uploaded by a producer to a show server are transmitted to a security server for encryption through the use of public/private key pairs. In some embodiments, the security server performs a check to determine if the received resource has previously been encrypted. This is accomplished by the security server's key manager comparing the unique identifier of the received resource against its list of all encrypted resources managed by the distribution network. If the key manager knows the resource id, e.g., it has already been encrypted, there is no need to duplicate the encryption and the resource is skipped over. According to one embodiment of the invention, the security server returns a link to the location or address of the encrypted resource to the show server that provided the resource. Where the resource identifier is unknown, the encryption is performed and the encrypted resource returned to the show server. The system is therefore capable of using a resource in a plurality of shows without the need to encrypt multiple copies of the resource.

The table of contents is used by the client to determine exactly which resources are needed to playback the show at the highest possible quality given the client configuration. It comprises a list of unique resource identifiers required to playback the requested show. Because each resources in the distribution system of the present invention is associated with a unique identifier, resources that have been retrieved and decrypted are available for use in a plurality of shows. The ability to reuse resources allows clients to reduce the time necessary to assemble all resources required to playback a show and furthermore reduces the total amount of storage space required by all show servers in the network to host shows.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A computer implemented method for receiving a securely distributed show comprising a plurality of rich media resources over a computerized network operative to connect a plurality of clients and servers, the method comprising:
retrieving the rich media resources in an encrypted format, each encrypted rich media resource identified by a unique resource id;
identifying the decryption keys corresponding to the unique resource ids of the encrypted rich media resources;
retrieving a session id and the identified decryption keys;
decrypting the encrypted rich media resources using the decryption keys; and
playing the show by presenting the retrieved decrypted rich media resources.

2. The method of claim 1, comprising:
generating heartbeat data packets at regular intervals while the show is playing, the heartbeat data packets used to determine how long said resource is played;
transmitting the heartbeat data packets identified by the session id to a security server for aggregation, the aggregation indexed by session id; and
transmitting the aggregated heartbeat data packets to a central server to generate payment information.

3. The method of claim 1, the method comprising downloading a media player to facilitate playback of the retrieved show, the media player identified by a unique player id.

4. The method of claim 3, the method comprising collecting and aggregating demographic information regarding an entity performing the downloading operation and associating it with the unique player id.

5. A computer implemented method for providing for the secure distribution of a show comprising a plurality of rich media resources over a computerized network operative to connect a plurality of clients and servers, the method comprising:
receiving each rich media resource in the show at a security server, each rich media resource identified by a unique resource id;
generating a plurality of encryption/decryption key pairs;
for at least some of the rich media resources in the show, encrypting each rich media resource using a different encryption key;
generating a plurality of records to associate each encrypted rich media resource with the appropriate decryption key;
transmitting the decryption keys and records to a central server; and
transmitting the decryption keys and records to other security servers on the network.

6. A computer implemented system for providing for the secure distribution of a show comprising a plurality of rich media resources over a computerized network operative to connect a plurality of clients and servers, the system comprising:
a security server to receive the rich media resources, each resource identified by a unique identifier, and handle key requests from client devices,
an encryption system to generate encryption/decryption key pairs, one pair for each resource, and to encrypt the rich media resources using a separate key for each resource;
a key manager to create records that associate each decryption key generated by the encryption system with the encrypted rich media resource that it is capable of decrypting; and
a show server to provide the media resources to security servers for encryption, to manage encrypted rich media resources, and to respond to client requests for rich media resources.

7. The system of claim 6, the system comprising a web server configured to serve media player software to a requesting client and further configured to collect and aggregate demographic data regarding all clients.

8. The system of claim 7, the web server comprising show server guides containing the address of show servers and the resources located thereon.

9. The system of claim 7, the system comprising a central server configured collect aggregated demographic data.

10. The system of claim 6, the system comprising:
a media player operative to retrieve a show comprising a plurality of rich media resources from the show server and issue requests to the security server for decryption keys corresponding to the unique ids of the rich media resources comprising the show.

11. The system of claim 10, the media player comprising functionality allowing it to generate heartbeat data packets for broadcast across a network.

12. The system of claim 11, wherein the heartbeat data packets are aggregated at the security server across a plurality of media players.

13. The system of claim 12, the system comprising a central server configured to collect heartbeat data packets from security servers connected to the network to create usage statistics regarding media players.

14. The method of claim 5, where encrypting at least some of the rich media resources comprises:
checking the unique resource id of the rich media resource to determine if the resource was previously encrypted; and
encrypting each rich media resource only if the resource was not previously encrypted.

15. The method of claim 14, the method comprising returning the address of an encrypted rich media resource where the step of checking the rich media resource id determines that the rich media resource was previously encrypted.
